(19) United States
(12) Patent Application Publication
(10) Pub. No.: US 2008/0115810 A1
(43) Pub. Date: May 22, 2008

(54) METHOD OF REACTIVATING ELECTRODE FOR ELECTROLYSIS

(75) Inventor: Akihiro KATO, Fujisawa-shi (JP)

Correspondence Address: SUGHRUE-265550, 2100 PENNSYLVANIA AVE. NW, WASHINGTON, DC, 20037-3213, US

(73) Assignee: PERMELEC ELECTRODE LTD., Fujisawa-shi (JP)

(21) Appl. No.: 11/930,743

(22) Filed: Oct. 31, 2007

(30) Foreign Application Priority Data
Nov. 20, 2006 (JP) 2006-313252
Sep. 5, 2007 (JP) 2007-230379

(51) Int. Cl. B08B 3/00

(52) U.S. Cl. 134/28

(57) ABSTRACT

The present invention provides a method of reactivating an electrode for electrolysis, which includes successively conducting two steps including an acid treatment step of dipping an electrode for electrolysis whose activity has decreased through electrolysis due to deposition of an electrode surface deposit containing a lead compound on a surface of the electrode for electrolysis in an aqueous solution containing from 5% by mass to 30% by mass of nitric acid and from 5% by mass to 20% by mass of hydrogen peroxide and a high-pressure water washing step of conducting high-pressure water washing under a pressure of from 50 to 100 MPa, or successively conducting three steps including an alkali treatment step of dipping in an alkali metal hydroxide aqueous solution of from 5% by mass to 20% by mass and the foregoing acid treatment step and the foregoing high-pressure water washing step, to remove an electrode surface deposit containing a lead compound or a lead compound and antimony oxide, thereby reactivating the electrode for electrolysis whose activity has decreased.

### FIELD OF THE INVENTION

The present invention relates to a method of reactivating an electrode for electrolysis whose activity has decreased through electrolysis due to deposition of an electrode surface deposit containing a lead compound or a lead compound and antimony oxide on a surface of the electrode for electrolysis in industrial electrolysis, for example, electrolysis for copper foil manufacture or copper plating, in particular, an electrode for electrolysis in which a thin film made of a metal or a metal alloy is formed by vacuum sputtering on a surface of an electrode substrate made of a valve metal or a valve metal alloy by vacuum sputtering and an electrode catalyst layer is formed to coat a surface of the thin film.

### BACKGROUND OF THE INVENTION

In electrolysis in industrial electrolysis, for example, copper foil manufacture or copper plating, an electrode for oxygen generation in which an electrode catalyst layer containing iridium oxide is directly formed to coat a surface of an electrode substrate made of a valve metal such as titanium and tantalum or a valve metal alloy has hitherto been used.

However, in an electrode for oxygen generation of this kind, when used for a certain period of time or more, an interface between an electrode substrate made of a valve metal such as titanium and tantalum or a valve metal alloy and an electrode catalyst layer such as iridium oxide is corroded, and a passive-state layer is formed on a surface of the substrate. Accordingly, it was difficult to achieve a reactivation treatment, and it was necessary that the substrate surface is shaven until a new surface has come out or that an electrode substrate is newly prepared.

On the other hand, in the case where an electrode for electrolysis in which a thin film made of a metal such as tantalum and niobium and having a thickness of from 0.5 to 3 μm is formed on a surface of an electrode substrate made of a valve metal such as titanium and tantalum or a valve metal alloy by vacuum sputtering such as ion plating and an electrode catalyst layer containing iridium oxide is formed to coat a surface of the thin film is used as an electrode for oxygen generation, an interface between the electrode substrate and the catalyst layer was not corroded (see, for example, Patent Document 1).

However, even in the foregoing electrode for oxygen generation, when used for electrolysis in copper foil manufacture or copper plating, on the electrode surface of the electrode for electrolysis, lead sulfate as a lead compound to be contained in an electrolyte or a compound containing lead sulfate and antimony oxide is deposited in the case of copper foil manufacture and lead oxide as a lead compound to be contained in an electrolyte or a compound containing lead oxide and antimony oxide is deposited in the case of electrolytic copper plating, respectively. At the electrolysis, lead to be contained in the electrolyte is deposited as lead oxide which is a good conductor, whereas antimony is deposited as antimony oxide which is a bad conductor. Also, lead oxide which is a good conductor changes to lead sulfate which is a bad conductor at the stopping of electrolysis. Furthermore, lead sulfate or lead oxide which is a lead compound and antimony oxide, each of which is an electrode surface deposit, drop out from the surface of the electrode for electrolysis at the start or stopping of electrolysis or during the electrolysis. As a result, the foregoing electrode for oxygen generation had such defects that the current distribution becomes non-uniform as an electrode for electrolysis, leading to a cause of defective thickness of a foil; and that it cannot be continuously used over a long period of time as an electrode for electrolysis.

In such case, in the foregoing electrode for oxygen generation, by scrapping off the surface of the electrode for electrolysis which has been used for the electrolysis by SCOTCH-BRITE (a registered trademark) which is a polisher manufactured by Sumitomo 3M Limited, the electrode surface deposit containing a lead compound or a lead compound and antimony oxide was removed, thereby reactivating the electrode for electrolysis.

However, in the foregoing electrode for oxygen generation, in the case of continuously using it for 3 months, the reactivation of the electrode for electrolysis with the foregoing polisher was difficult.

Patent Document 1: Japanese Patent No. 2761751

### SUMMARY OF THE INVENTION

An object of the invention is to solve the defects of the foregoing related-art methods and to provide a method of efficiently and easily removing an electrode surface deposit containing a lead compound or a lead compound and antimony oxide as deposited on a surface of an electrode for electrolysis whose activity has decreased through electrolysis in industrial electrolysis, for example, copper foil manufacture or copper plating, due to deposition of the electrode surface deposit containing a lead compound or a lead compound and antimony oxide, in particular, on an electrode for electrolysis in which a thin film made of a metal or a metal alloy is formed by vacuum sputtering on a surface of an electrode substrate made of a valve metal or a valve metal alloy and an electrode catalyst layer is formed to coat a surface of the thin film, thereby attaining reactivation of the electrode for electrolysis.

Then, in order to attain the foregoing object, a first aspect of the invention is to provide a method of reactivating an electrode for electrolysis, which comprises successively conducting an acid treatment step of dipping an electrode for electrolysis whose activity has decreased through electrolysis due to deposition of an electrode surface deposit containing a lead compound on a surface of the electrode for electrolysis in an aqueous solution containing from 5% by mass to 30% by mass of nitric acid and from 5% by mass to 20% by mass of hydrogen peroxide and a high-pressure water washing step of conducting high-pressure water washing under a pressure of from 50 to 100 MPa, to remove the electrode surface deposit containing lead, thereby reactivating the electrode for electrolysis whose activity has decreased by two steps of the acid treatment step and the high-pressure water washing step.

Also, a second aspect of the invention is to provide the reactivation method comprising the foregoing two steps of the acid treatment step and the high-pressure water washing step, wherein the electrode surface deposit is an electrode surface deposit containing a lead compound and antimony oxide.

Also, a third aspect of the invention is to provide the reactivation method comprising the foregoing two steps of the acid treatment step and the high-pressure water washing step, wherein the lead compound is lead oxide.

Also, a fourth aspect of the invention is to provide the reactivation method comprising the foregoing two steps of the acid treatment step and the high-pressure water washing step, wherein the electrolysis is electrolysis for copper plating.

Also, a fifth aspect of the invention is to provide the reactivation method comprising the foregoing two steps of the acid treatment step and the high-pressure water washing step, wherein the electrode for electrolysis is an electrode for electrolysis prepared by forming a thin film made of a metal or a metal alloy on a surface of an electrode substrate made of a valve metal or a valve metal alloy by vacuum sputtering and coating a surface of the thin film with an electrode catalyst layer.

Also, a sixth aspect of the invention is to provide the reactivation method comprising the foregoing two steps of the acid treatment step and the high-pressure water washing step, wherein the thin film is a thin film made of a metal of at least one member selected from the group consisting of titanium, tantalum, niobium, zirconium and hafnium or an alloy thereof.

Also, a seventh aspect of the invention is to provide the reactivation method comprising the foregoing two steps of the acid treatment step and the high-pressure water washing step, wherein the electrode catalyst layer is an electrode catalyst layer containing iridium oxide.

Also, an eighth aspect of the invention is to provide the reactivation method comprising the foregoing two steps of the acid treatment step and the high-pressure water washing step, further comprising forming an electrode catalyst layer after removing the electrode surface deposit.

Furthermore, a ninth aspect of the invention is to provide a method of reactivating an electrode for electrolysis, which comprises successively conducting an alkali treatment step of dipping an electrode for electrolysis whose activity has decreased through electrolysis due to deposition of an electrode surface deposit containing a lead compound on a surface of the electrode for electrolysis in an alkali metal hydroxide aqueous solution of from 5% by mass to 20% by mass, an acid treatment step of dipping in an aqueous solution containing from 5% by mass to 30% by mass of nitric acid and from 5% by mass to 20% by mass of hydrogen peroxide and a high-pressure water washing step of conducting high-pressure water washing under a pressure of from 50 to 100 MPa, to remove the electrode surface deposit containing lead and antimony, thereby reactivating the electrode for electrolysis whose activity has decreased.

Also, a tenth aspect of the invention is to provide the reactivation method comprising the foregoing three steps of the alkali treatment step, the acid treatment step and the high-pressure water washing step, wherein the electrode surface deposit is an electrode surface deposit containing a lead compound and antimony oxide.

Also, an eleventh aspect of the invention is to provide the reactivation method comprising the foregoing three steps of the alkali treatment step, the acid treatment step and the high-pressure water washing step, wherein the lead compound is lead sulfate.

Furthermore, a twelfth aspect of the invention is to provide the reactivation method comprising the foregoing three steps of the alkali treatment step, the acid treatment step and the high-pressure water washing step, wherein the electrolysis is electrolysis for copper foil manufacture.

Furthermore, a thirteenth aspect of the invention is to provide the reactivation method comprising the foregoing three steps of the alkali treatment step, the acid treatment step and the high-pressure water washing step, wherein the electrode for electrolysis is an electrode for electrolysis prepared by forming a thin film made of a metal or a metal alloy on a surface of an electrode substrate made of a valve metal or a valve metal alloy by vacuum sputtering and coating a surface of the thin film with an electrode catalyst layer.

Furthermore, a fourteenth aspect of the invention is to provide the reactivation method comprising the foregoing three steps of the alkali treatment step, the acid treatment step and the high-pressure water washing step, wherein the thin film is a thin film made of a metal of at least one member selected from titanium, tantalum, niobium, zirconium and hafnium or an alloy thereof.

Furthermore, a fifteenth aspect of the invention is to provide the reactivation method comprising the foregoing three steps of the alkali treatment step, the acid treatment step and the high-pressure water washing step, wherein the electrode catalyst layer is an electrode catalyst layer containing iridium oxide.

Furthermore, a sixteenth aspect of the invention is to provide the reactivation method comprising the foregoing three steps of the alkali treatment step, the acid treatment step and the high-pressure water washing step, further comprising forming an electrode catalyst layer after removing the electrode surface deposit.

According to the invention, by an acid treatment step of an electrode surface deposit containing lead oxide as a lead compound or lead oxide and antimony oxide with an aqueous solution containing nitric acid and hydrogen peroxide, lead hydroxide and antimony oxide can be dissolved and removed; and by a high-pressure water step of subjecting the remaining lead oxide and antimony oxide to high-pressure water washing, the lead oxide and antimony oxide can be physically removed. Also, in the case where the lead compound is lead sulfate, by an alkali treatment step with a sodium hydroxide aqueous solution, an electrode surface deposit containing lead sulfate or lead sulfate and antimony oxide is converted into lead hydroxide; next, by an acid treatment step with an aqueous solution containing nitric acid and hydrogen peroxide, the lead hydroxide and antimony oxide can be dissolved and removed; and by a high-pressure water washing step of subjecting the remaining lead and antimony to high-pressure water washing, the lead and antimony can be physically removed. Accordingly, the electrode surface deposit containing a lead compound or a lead compound and antimony oxide can be efficiently and easily removed, whereby the reactivation of the electrode for electrolysis has become easy.

### DETAILED DESCRIPTION OF THE INVENTION

The invention is hereunder described in detail.

In the case where the electrolysis is, for example, electrolysis for copper plating, an electrode surface deposit containing lead oxide as a lead compound or lead oxide and antimony is deposited on a surface of an electrode for electrolysis, whereby the activity of the electrode for electrolysis decreases. In such case, in the invention, first of all, as an acid treatment step, the electrode for electrolysis whose activity has decreased is dipped in an aqueous solution containing from 5% by mass to 30% by mass of nitric acid and from 5% by mass to 20% by mass of hydrogen peroxide for from 5 to 15 hours, whereby the lead hydroxide and antimony oxide are dissolved in and removed with the aqueous solution containing nitric acid and hydrogen peroxide. Next, as a high-pressure water washing step, the resulting electrode for electrolysis is subjected to high-pressure water washing under a pressure of from 50 to 100 MPa to physically remove the remaining lead and antimony compound, thereby reactivating the electrode for electrolysis whose activity has decreased.

On the other hand, in the case where the electrolysis is, for example, electrolysis for copper foil manufacture, an electrode surface deposit containing lead sulfate as a lead compound or lead sulfate and antimony is deposited on a surface of an electrode for electrolysis, whereby the activity of the electrode for electrolysis decreases. In such case, in the invention, first of all, as an alkali treatment step, the electrode for electrolysis whose activity has decreased is dipped in an alkali metal hydroxide aqueous solution of from 5% by mass to 20% by mass for from 1 to 3 hours, whereby lead sulfate in the electrode surface deposit containing lead and antimony is converted into lead hydroxide by a sodium hydroxide aqueous solution. Next, as an acid treatment step, the electrode for electrolysis is dipped in an aqueous solution containing from 5% by mass to 30% by mass of nitric acid and from 5% by mass to 20% by mass of hydrogen peroxide for from 5 to 15 hours, whereby the lead hydroxide and antimony oxide are dissolved in and removed with the aqueous solution containing nitric acid and hydrogen peroxide. Furthermore, as a high-pressure water washing step, the resulting electrode for electrolysis is subjected to high-pressure water washing under a pressure of from 50 to 100 MPa to physically remove the remaining lead and antimony compound, thereby reactivating the electrode for electrolysis whose activity has decreased.

In the acid treatment step, when the concentration of nitric acid in the aqueous solution containing nitric acid and hydrogen peroxide exceeds 30% by mass, or the concentration of hydrogen peroxide in the aqueous solution containing nitric acid and hydrogen peroxide exceeds 20% by mass, not only the substrate of the electrode for electrolysis, for example, titanium starts to be corroded, but there is a possibility that the electrode catalyst layer of the electrode for electrolysis peels away. On the other hand, when the concentration of nitric acid is less than 5% by mass, or the concentration of hydrogen peroxide is less than 5% by mass, the reaction for dissolving lead hydroxide and antimony oxide is insufficient. For that reason, it is necessary that the concentration of nitric acid in the aqueous solution containing nitric acid and hydrogen peroxide is from 5% by mass to 30% by mass; and that the concentration of hydrogen peroxide in the aqueous solution containing nitric acid and hydrogen peroxide is from 5% by mass to 20% by mass. Also, the dipping time of the electrode for electrolysis in the aqueous solution containing nitric acid and hydrogen peroxide is required to be 5 hours or more, and it is preferably 15 hours or more.

In the alkali treatment step, the alkali metal hydroxide is preferably sodium hydroxide or potassium hydroxide. When the concentration of the alkali metal hydroxide in the aqueous solution exceeds 20% by mass, the substrate of the electrode for electrolysis, for example, titanium starts to be corroded, and therefore, it is necessary that the concentration of the alkali metal hydroxide in the aqueous solution is not more than 20% by mass. On the other hand, when the concentration of the alkali metal hydroxide in the aqueous solution is less than 5% by mass, the reaction for converting lead sulfate in the electrode surface deposit containing lead and antimony into lead hydroxide is not sufficient. Accordingly, it is necessary that the concentration of the alkali metal hydroxide in the aqueous solution is from 5% by mass to 20% by mass. Also, when the dipping time of the electrode for electrolysis in the alkali metal hydroxide aqueous solution exceeds 3 hours, the substrate of the electrode for electrolysis, for example, titanium starts to be corroded, and therefore, it is necessary that the dipping time of the electrode for electrolysis in the alkali metal hydroxide aqueous solution is not more than 3 hours.

Furthermore, in the high-pressure water washing step, in order to physically remove the remaining lead and antimony compound, it is necessary that high-pressure water washing is conducted under a pressure of from 50 to 100 MPa. When the pressure for high-pressure water washing is less than 50 MPa, the removal efficiency is low, whereas when it exceeds 100 MPa, there is a possibility that the substrate of the electrode for electrolysis, for example, titanium is bored.

Moreover, in the invention, as described previously, in the case where the electrode catalyst layer is consumed after the removal of the electrode deposit, an electrode catalyst layer is newly formed by a method as described later.

For the electrode substrate of the electrode for electrolysis, a metallic material is used, and its material quality and shape are not particularly limited so far as it has conductivity and appropriate stiffness. For example, a valve metal having good corrosion resistance, for example, Ti, Ta, Nb and Zr or an alloy thereof is suitable. When the surface of the electrode substrate is made sufficiently anticorrosive by an amorphous layer-containing anticorrosive coating, it is also possible to use a metal with good conductivity, for example, Cu and Al. The electrode substrate is properly subjected in advance to surface roughing by annealing, blasting or the like or a physical or chemical pretreatment, for example, surface cleaning by acid washing or the like as the need arises.

Next, a thin film made of a metal is formed on a surface of the substrate. The metal for forming the thin film is not particularly limited so far as it has good conductivity and corrosion resistance or has good adhesion to the substrate or the electrode catalyst layer. Typical examples of substances include titanium, tantalum, niobium, zirconium and hafnium, all of which have excellent corrosion resistance, and alloys thereof. These materials have especially good adhesiveness to an electrode substrate made of a valve metal, for example, titanium.

As a method for forming such a thin film on the electrode substrate, a thin film forming method by vacuum sputtering is employed. According to the vacuum sputtering method, it is easy to obtain a thin film in a grain boundary-free amorphous form. For the vacuum sputtering, various methods such as direct-current sputtering, high-frequency sputtering, arc ion plating, ion beam plating, and a cluster ion beam method are applicable. A thin film having desired physical properties can be obtained by properly setting up conditions such as vacuum degree, substrate temperature, composition or purity of a target plate, and deposition rate (electrical power to be applied). A thickness of the surface modified layer due to the formation of a thin film is usually in the range of from 0.1 to 10 μm and may be chosen from the practically useful standpoints of corrosion resistance, productivity and the like. Thus, the electrode substrate whose surface has been modified by the formation of a thin film of a grain boundary-free amorphous layer is able to bring excellent characteristics against thermal oxidation of its surface, namely remarkable characteristics in growth behavior of the oxide film. Each of a titanium plate prepared by subjecting a commercially available pure titanium plate (TP2B) to surface cleaning by degreasing and acid washing and a titanium plate prepared by forming a thin film coat of pure titanium on a surface thereof by vacuum sputtering while using a pure titanium plate as a target was thermally treated in an electric furnace with uniform temperature distribution in an air atmosphere at from 450 to 600° C. for from 0 to 5 hours under a condition capable of forming a minute oxide film on titanium. As a result, as compared with the former principle titanium plate, the latter surface-modified titanium plate revealed distinct differences such that the color tone was monotonous; that color unevenness such as spots was not observed; that the growth of an oxide film was extremely homogeneous; and that the growth speed of an oxide film was slow. This effect for suppressing the oxide film growth is remarkable when the material composition of the amorphous layer is made of an ally composition but not a single metal. It is thought that the homogenization and suppressing effect of the surface-modified layer against the thermal oxidation brings not only a relaxation of the thermal influence in an electrode catalyst layer forming step as described later but a relaxation effect against electrochemical oxidation at the electrolysis, thereby largely contributing to an enhancement of durability of the electrode.

The electrode substrate on which the thin film has been formed is then coated with an electrode catalyst layer to provide an electrode for electrolysis. As the electrode catalyst layer, various known materials can be applied depending upon the utility, and the electrode catalyst layer is not particularly limited. For the oxygen generation reaction requiring durability, materials containing a platinum-group metal oxide such as iridium oxide are suitable. As a method for coating with the electrode catalyst layer, various methods are known and can be properly applied. A thermal decomposition method is a typical method. A salt of a raw material of the electrode coating layer component metal, for example, chlorides, nitrates, alkoxides and resonates is dissolved in a solvent such as hydrochloric acid, nitric acid, alcohols and organic solvents to form a coating liquid, the coating liquid is applied on a surface of the surface-modified substrate and after drying, thermally treated in a backing furnace in an oxidizing atmosphere, for example, in air.

Besides, it is also possible to apply a thick film method in which a metal oxide is previously prepared and appropriate organic binder and organic solvent are added thereto to form a paste, which is then printed on an electrode substrate and baked, or a CVD method. Also, a metal oxide layer may be provided as an interlayer by a method in which prior to coating with the electrode catalyst layer, the foregoing surface-modified substrate is thermally treated to form an extremely thin high-temperature oxidized film layer as an interlayer on the surface thereof, a thermal decomposition, a CVD method, or the like. By this interlayer, an adhesive strength of the electrode catalyst layer increases, and a protective effect against thermal oxidation or electrical oxidation of the substrate can be expected, whereby it is possible to attain not only the foregoing essential effects by the thin film on the substrate but a further enhancement of durability of the electrode for electrolysis.

### EXAMPLES

Next, the invention is specifically described with reference to the following Examples, but it should not be construed that the invention is limited thereto.

### Example 1

A surface of a JIS first-class titanium plate was subjected to a dry blast treatment with iron grid (#120 size) and an acid washing treatment in a 20% sulfuric acid aqueous solution (at 105° C.) for 10 minutes, thereby conducting a washing treatment of the electrode substrate. The washed electrode substrate was set in an arc ion plating apparatus and subjected to sputtering coating with a pure titanium material. The coating condition is as follows.

Target: JIS first-class titanium disc (with the back surface being water-cooled)

Vacuum degree: 1.0×10⁻² Torr (purge with Ar gas being introduced)

Applied electrical power: 500 W (3.0 kV)

Substrate temperature: 150° C. (at the sputtering)

Time: 35 minutes

Coating thickness: 2 microns (calculated as a weight increase)

As a result of X-ray diffraction analysis which was conducted after sputtering coating, a sharp crystalline peak assigned to the substrate bulk and a broad pattern assigned to the sputtering coating were observed, and it was noted that the coating was amorphous.

Next, iridium tetrachloride and tantalum pentachloride were dissolved in 35% hydrochloric acid to form a coating liquid, which was then brush coated on the foregoing sputtering coating treatment-accomplished substrate. After drying, the resulting substrate was subjected to thermal decomposition coating in an air-circulating electric furnace (at 550° C. for 20 minutes) to form an electrode catalyst layer made of a solid solution of iridium oxide and tantalum oxide. With respect to the coating thickness of the brush coating of one time, the amount of the foregoing coating liquid was set up such that it was substantially 1.0 g/m² relative to the iridium metal.

The operation of from coating to baking was repeated 12 times to prepare an electrode for electrolysis. The thus prepared electrode for electrolysis was subjected to electrolysis under the following condition.

Current density: 125 A/dm²

Electrolysis temperature: 60° C.

Electrolyte: Simulated liquid for copper plating containing lead chloride

The used electrode for electrolysis became inoperable after a lapse of 6 months. Next, this electrode for electrolysis was subjected to a reactivation treatment under the following condition.

An electrode surface deposit containing lead oxide was formed on the surface of the electrode. The electrode for electrolysis having an electrode surface deposit containing lead oxide was dipped in an aqueous solution of 5% by mass of nitric acid and 5% by mass of hydrogen peroxide for 15 hours as an acid treatment step and thereafter subjected to high-pressure water washing under a pressure of 50 MPa as a high-pressure water washing step. As a result, the electrode surface deposit containing lead oxide deposited on the surface of the electrode for electrolysis could be completely removed.

Thereafter, the amount of iridium oxide of the electrode catalyst layer of the present electrode for electrolysis was measured. When the amount of IrO₂ was less than 5 g/m², a coating was added, whereas when the amount of iridium oxide was 5 g/m² or more, the electrode for electrolysis was reused as it was.

The electrolysis was conducted under the foregoing electrolysis condition. As a result, the electrode for electrolysis could be used over 6 months likewise a new article.

### Example 2

In the foregoing Example 1, a simulated liquid for copper plating containing lead chloride and antinomy oxide was used as the electrolyte, and the same operations were conducted under the same conditions as in Example 1. As a result, the same results as in Example 1 were obtained.

### Example 3

A surface of a JIS first-class titanium plate was subjected to a dry blast treatment with iron grid (#120 size) and an acid washing treatment in a 20% sulfuric acid aqueous solution (at 105° C.) for 10 minutes, thereby conducting a washing treatment of the electrode substrate. The washed electrode substrate was set in an arc ion plating apparatus and subjected to sputtering coating with a pure titanium material. The coating condition is as follows.

Target: JIS first-class titanium disc (with the back surface being water-cooled)

Vacuum degree: 1.0×10⁻² Torr (purge with Ar gas being introduced)

Applied electrical power: 500 W (3.0 kV)

Substrate temperature: 150° C. (at the sputtering)

Time: 35 minutes

Coating thickness: 2 microns (calculated as a weight increase)

As a result of X-ray diffraction analysis which was conducted after sputtering coating, a sharp crystalline peak assigned to the substrate bulk and a broad pattern assigned to the sputtering coating were observed, and it was noted that the coating was amorphous.

Next, iridium tetrachloride and tantalum pentachloride were dissolved in 35% hydrochloric acid to form a coating liquid, which was then brush coated on the foregoing sputtering coating treatment-accomplished substrate. After drying, the resulting substrate was subjected to thermal decomposition coating in an air-circulating electric furnace (at 550° C. for 20 minutes) to form an electrode catalyst layer made of a solid solution of iridium oxide and tantalum oxide. With respect to the coating thickness of the brush coating of one time, the amount of the foregoing coating liquid was set up such that it was substantially 1.0 g/m² relative to the iridium metal.

The operation of from coating to baking was repeated 12 times to prepare an electrode for electrolysis. The thus prepared electrode for electrolysis was subjected to electrolysis under the following condition.

Current density: 125 A/dm²

Electrolysis temperature: 60° C.

Electrolyte: Simulated liquid for copper foil manufacture containing lead sulfate

The used electrode for electrolysis became inoperable after a lapse of 6 months. Next, this electrode for electrolysis was subjected to a reactivation treatment under the following condition.

An electrode for electrolysis having an electrode surface deposit containing lead sulfate and antimony oxide on a surface thereof was dipped in a 5% by mass sodium hydroxide aqueous solution for 3 hours as an alkali treatment step, dipped in an aqueous solution of 5% by mass of nitric acid and 5% by mass of hydrogen peroxide for 15 hours as an acid treatment step and thereafter subjected to high-pressure water washing under a pressure of 50 MPa as a high-pressure water washing step. As a result, the electrode surface deposit containing lead sulfate deposited on the surface of the electrode for electrolysis could be completely removed.

Thereafter, the amount of iridium oxide of the electrode catalyst layer of the present electrode for electrolysis was measured. When the amount of IrO₂ was less than 5 g/m², a coating was added, whereas when the amount of iridium oxide was 5 g/m² or more, the electrode for electrolysis was reused as it was. The electrolysis was conducted under the foregoing electrolysis condition. As a result, the electrode for electrolysis could be used over 6 months likewise a new article.

### Example 4

The electrode as prepared in Example 3 was used at a current density of 80 A/dm² at an electrolysis temperature of 55° C. As a result, it became impossible to manufacture a foil after a lapse of 10 months.

That electrode was dipped in a 10% by mass sodium hydroxide aqueous solution for one hour, dipped in an aqueous solution of 10% by mass of nitric acid and 10% by mass of hydrogen peroxide for 15 hours and thereafter subjected to high-pressure water washing under a pressure of 70 MPa. As a result, the electrode surface deposit containing lead and antimony deposited on the surface of the electrode for electrolysis could be completely removed, and the electrode for electrolysis could be used for an additional 10 months.

### Example 5

The electrode as prepared in Example 3 was used at a current density of 50 A/dm² at an electrolysis temperature of 45° C. As a result, it became impossible to manufacture a foil after a lapse of 12 months.

That electrode was dipped in a 20% by mass sodium hydroxide aqueous solution for 2 hours, dipped in an aqueous solution of 30% by mass of nitric acid and 20% by mass of hydrogen peroxide for 15 hours and thereafter subjected to high-pressure water washing under a pressure of 100 MPa. As a result, the electrode surface deposit containing lead and antimony deposited on the surface of the electrode for electrolysis could be completely removed, and the electrode for electrolysis could be used for an additional 12 months.

### Example 6

In the foregoing Example 3, a simulated liquid for copper foil manufacture containing lead sulfate and antinomy oxide was used as the electrolyte, and the same operations were conducted under the same conditions as in Example 3. As a result, the same results as in Example 3 were obtained.

### Comparative Example 1

On the other hand, in the case where only nitric acid or hydrogen peroxide was used in place of the aqueous solution containing nitric acid and hydrogen peroxide, the efficiency of the dissolution and removal reaction of a deposit was bad. Also, in the case where sulfuric acid was used in place of nitric acid, the reaction efficiency was similarly extremely bad, and the resulting electrode for electrolysis could not be used. Furthermore, in the case where hydrochloric acid was used in place of nitric acid, there was involved a defect that the working environment became worse.

The invention is applicable to various reactivation methods of electrodes for electrolysis for not only manufacture of an electrolytic copper powder or an electrolytic copper foil or copper plating but others.

While the present invention has been described in detail and with reference to specific embodiments thereof, it will be apparent to one skilled in the art that various changes and modifications can be made therein without departing from the spirit and scope thereof.

This application is based on Japanese Patent Application Nos. 2006-313252 (filed Nov. 20, 2006) and 2007-230379 (filed Sep. 5, 2007), and the contents thereof are herein incorporated by reference.

What is claimed is:

1. A method of reactivating an electrode for electrolysis, which comprises successively conducting an acid treatment step of dipping an electrode for electrolysis whose activity has decreased through electrolysis due to deposition of an electrode surface deposit containing a lead compound on a surface of the electrode for electrolysis in an aqueous solution containing from 5% by mass to 30% by mass of nitric acid and from 5% by mass to 20% by mass of hydrogen peroxide and a high-pressure water washing step of conducting high-pressure water washing under a pressure of from 50 to 100 MPa, to remove the electrode surface deposit containing lead, thereby reactivating the electrode for electrolysis whose activity has decreased.

2. The method of reactivating an electrode for electrolysis according to claim 1, wherein the electrode surface deposit is an electrode surface deposit containing a lead compound and antimony oxide.

3. The method of reactivating an electrode for electrolysis according to claim 1, wherein the lead compound is lead oxide.

4. The method of reactivating an electrode for electrolysis according to claim 1, wherein the electrolysis is electrolysis for copper plating.

5. The method of reactivating an electrode for electrolysis according to claim 1, wherein the electrode for electrolysis is an electrode for electrolysis prepared by forming a thin film made of a metal or a metal alloy on a surface of an electrode substrate made of a valve metal or a valve metal alloy by vacuum sputtering and coating a surface of the thin film with an electrode catalyst layer.

6. The method of reactivating an electrode for electrolysis according to claim 5, wherein the thin film is a thin film made of a metal of at least one member selected from the group consisting of titanium, tantalum, niobium, zirconium and hafnium or an alloy thereof.

7. The method of reactivating an electrode for electrolysis according to claim 5, wherein the electrode catalyst layer is an electrode catalyst layer containing iridium oxide.

8. The method of reactivating an electrode for electrolysis according to claim 1, further comprising forming an electrode catalyst layer after removing the electrode surface deposit.

9. A method of reactivating an electrode for electrolysis, which comprises successively conducting an alkali treatment step of dipping an electrode for electrolysis whose activity has decreased through electrolysis due to deposition of an electrode surface deposit containing a lead compound on a surface of the electrode for electrolysis in an alkali metal hydroxide aqueous solution of from 5% by mass to 20% by mass, an acid treatment step of dipping in an aqueous solution containing from 5% by mass to 30% by mass of nitric acid and from 5% by mass to 20% by mass of hydrogen peroxide and a high-pressure water washing step of conducting high-pressure water washing under a pressure of from 50 to 100 MPa, to remove the electrode surface deposit containing lead and antimony, thereby reactivating the electrode for electrolysis whose activity has decreased.

10. The method of reactivating an electrode for electrolysis according to claim 9, wherein the electrode surface deposit is an electrode surface deposit containing a lead compound and antimony oxide.

11. The method of reactivating an electrode for electrolysis according to claim 9, wherein the lead compound is lead sulfate.

12. The method of reactivating an electrode for electrolysis according to claim 9, wherein the electrolysis is electrolysis for copper foil manufacture.

13. The method of reactivating an electrode for electrolysis according to claim 9, wherein the electrode for electrolysis is an electrode for electrolysis prepared by forming a thin film made of a metal or a metal alloy on a surface of an electrode substrate made of a valve metal or a valve metal alloy by vacuum sputtering and coating a surface of the thin film with an electrode catalyst layer.

14. The method of reactivating an electrode for electrolysis according to claim 13, wherein the thin film is a thin film made of a metal of at least one member selected from the group consisting of titanium, tantalum, niobium, zirconium and hafnium or an alloy thereof.

15. The method of reactivating an electrode for electrolysis according to claim 13, wherein the electrode catalyst layer is an electrode catalyst layer containing iridium oxide.

16. The method of reactivating an electrode for electrolysis according to claim 9, further comprising forming an electrode catalyst layer after removing the electrode surface deposit.
